(19) United States
(12) Patent Application Publication
(10) Pub. No.: US 2008/0131246 A1
(43) Pub. Date: Jun. 5, 2008

(54) REMOVABLE TIRE CADDY AND METHOD OF USE

(76) Inventor: Joseph M. Altman, Southfield, MI (US)

Correspondence Address: TRASK BRITT, P.O. BOX 2550, SALT LAKE CITY, UT, 84110, US

(21) Appl. No.: 11/949,656

(22) Filed: Dec. 3, 2007

Related U.S. Application Data
(60) Provisional application No. 60/872,953, filed on Dec. 5, 2006.

(51) Int. Cl. B62D 43/04

(52) U.S. Cl. 414/463; 224/42.23; 280/79.4; 29/802

(57) ABSTRACT

A removable tire caddy and method of use for providing convenient access and manipulation of a vehicle-mounted spare tire. The removable tire caddy includes a unitary carriage designed to support a tire on its frame and at least one wheel coupled to the frame. In the center of the carriage is a structure for engaging a cable of a spare tire lift-and-carry apparatus that extends or retracts to move the spare tire and wheeled carriage between a release position and a storage position under the vehicle. When the carriage is disengaged from the cable, the user is able to move the tire about easily, as the weight of the tire and carriage is borne by the at least one wheel.

### CROSS-REFERENCE TO RELATED APPLICATION

This application claims the benefit of U.S. Provisional Patent Application Ser. No. 60/872,953, filed Dec. 5, 2006, the disclosure of which is incorporated herein by reference in its entirety.

### FIELD OF THE INVENTION

The present invention relates generally to spare tire vehicle mounting apparatus and, more particularly, pertains to an improved removable tire caddy, including a method of use, for providing convenient access and manipulation of a vehicle mounted spare tire.

### BACKGROUND

Conventionally, the use of spare tire vehicle mounting apparatus, including a method thereof, is known to a person of skill in the art. Several conventional apparatuses include a tire rack, a retaining cable, and a spare tire carrier. However, these apparatuses do not provide convenient access and manipulation of a vehicle mounted spare tire when the tire is removed from or rescuered to the vehicle.

Another spare tire mounting apparatus conventionally known is disclosed in U.S. Pat. No. 7,021,884, entitled “Removable Tire Caddy and Method of Use,” which is issued to the inventor of the current invention and the disclosure of which is incorporated by reference herein. The apparatus shown in FIGS. 1 through 4 and described below.

As illustrated in FIGS. 1 through 4, the conventional removable tire caddy 10 comprises two main assemblies. The first assembly includes the carriage 20 and the second assembly includes the spare tire lift and carry apparatus 50.

The conventional carriage 20 comprises a frame 22 for supporting a spare tire 16. The frame includes four arms 24 that radiate from a central portion 32 and extend to a distance sufficient to contact and support an ample portion of the spare tire 16. The arms 24 of the carriage 20 may be bent for the purpose of keeping the spare tire 16 placed centrally on the carriage 20. FIG. 2 best illustrates the contouring of the arms 24 that raises the central portion 32 higher that the ends of the arms 24 to fit within the central cavity of the spare tire 16. At the end of the arms 24 there are included two wheels 26, a handle 30, and a foot 28. The wheels 26 may be located at two ends of the arms 20. The handle 30 may be located at the end of the arms 24. The foot 28 may be located at another end of the arms 24 that would assist in supporting the carriage 20 in union with the wheels 26 when not in motion.

An engagement device 34 is incorporated on the central portion of the carriage 20. The cable engagement device 34 may be used to connect the carriage to a spare tire lift and carry apparatus 50.

The spare tire lift and carry apparatus 50 are conventionally known in the art. The apparatus 50 includes a flexible member 52, such as a chain or cable, connected directly to the spare tire 16 or a support hub device via a coupling device 54 that couples to the engagement device 34 for supporting the spare tire 16. The flexible member 52 is connected to a take up means 56 for retracting the flexible member 52 and the spare tire 16. A motivator 58 such as a crank, ratchet, motor, lever, etc., could drive the take up means 56. The entire apparatus 50 is mounted underneath the undercarriage 14 of the vehicle 12.

When the user desires to access the spare tire 16, the user activates the motivator 58, which is illustrated in FIGS. 1 and 3 as a crank. The crank would extend the flexible member 52 from the take up means 56 and lower the carriage 20, with the spare tire 16, to the ground allowing the user to roll the carriage 20 out from under the vehicle 12.

While the above-mentioned devices purport to fulfill their respective, particular objectives and requirements, they do not disclose an improved removable tire caddy and method of use. It would be desirable to provide an improved removable tire caddy suitable for use in harsh environments typically encountered on the underside of a vehicle where a tire might be stored. Moreover, it would be desirable to provide an improved removable tire caddy that is manufactured from a unitary piece, providing material cost and manufacturing time savings. Furthermore, it would be desirable to provide a protective barrier to a tire, with its mounted rim, from road or surface debris. Finally, it would be desirable to provide an improved tire caddy that is lightweight, provides structural support for the tire, and reduces undesirable noise, vibration and harshness (“NVH”) encountered with the conventional spare tire mounting apparatuses when mounted on an operational vehicle.

### BRIEF SUMMARY OF THE INVENTION

Embodiments of the invention provide an improved removable tire caddy and method of use construction wherein the same can be utilized for providing convenient access and manipulation of a vehicle mounted spare tire.

An embodiment of the invention generally comprises a unitary carriage configured to support a tire on one or more wheels. In the center of the carriage is a site to engage a cable of a spare tire lift-and-carry apparatus that extends or retracts to move the spare tire and wheeled carriage between a release position and a storage position under the vehicle. Furthermore, when the carriage is disengaged from the cable, the user is able to move the tire about easily, as the weight of the tire and carriage are born by the wheels.

In another embodiment, the invention comprises a unitary member that radiates from a central portion to an outer edge configured to engage a spare tire. The unitary member further includes a plurality of wheel connector supports, each for receiving at least one wheel assembly.

In embodiments of the invention, a removable tire caddy for use with a vehicle is also provided.

In a further embodiment of the invention, a method of using a removable tire caddy is provided.

It is therefore an advantage of the invention to provide an improved removable tire caddy and method of use for providing convenient access and manipulation of a vehicle mounted spare tire.

It is another advantage of the invention is to provide an improved removable tire caddy and method of use, which includes a unitary carriage designed to support a tire on one or more wheels. In the center of the carriage is a site to engage a cable of a spare tire lift-and-carry apparatus that extends or retracts moving the spare tire and wheeled carriage between a release position and a storage position under the vehicle.

It is a further advantage of the invention to provide an improved removable tire caddy and method of use that is suitable for use in harsh environments typically encountered on the underside of a vehicle.

An even further advantage of the invention is to provide an improved removable tire caddy and method of use that provides a protective barrier to a tire rim from surface impediment and debris.

Still yet another advantage of the invention is to provide an improved removable tire caddy and method of use that is lightweight and provides structural support for the spare tire, while reducing undesirable noise, vibration and harshness when attached to an operational vehicle.

Other advantages and features of the invention will become apparent when viewed in light of the detailed description of the various embodiments of the invention when taken in conjunction with the attached drawings and appended claims.

### BRIEF DESCRIPTION OF THE DRAWINGS

FIG. 1 shows a rear profile view of a conventional removable tire caddy suspended underneath a vehicle in the storage position.

FIG. 2 shows a perspective view of the conventional tire caddy showing the relation of the carriage to the tire.

FIG. 3 shows a side profile view of the conventional tire caddy suspended underneath a vehicle in the storage position.

FIG. 4 shows a cross section view of the conventional tire caddy.

FIG. 5 shows a perspective view of an improved removable tire caddy in accordance with a first embodiment the invention.

FIG. 6 shows a cross section view of a unitary carriage in accordance with the first embodiment of the invention.

FIG. 7 shows a cross section view of the unitary carriage in accordance with the first embodiment of the invention.

FIG. 8 shows a cross section view of another unitary carriage in accordance with a second embodiment of the invention.

FIG. 9 shows a perspective view of yet another unit carriage in accordance with a third embodiment of the invention.

FIG. 10 shows a cross section view of the unitary carriage in accordance with the third embodiment of the invention.

FIG. 11 shows a perspective view of still another unitary carriage in accordance with a fourth embodiment of the invention.

### DETAILED DESCRIPTION OF THE INVENTION

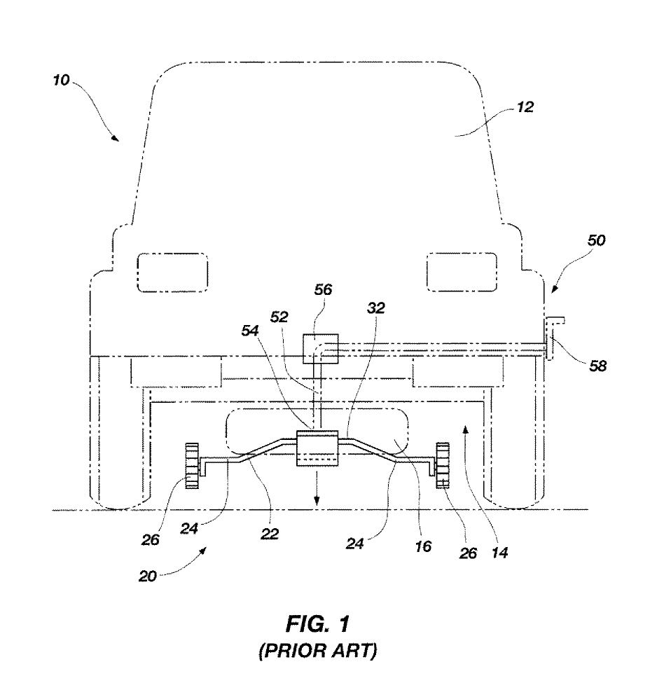

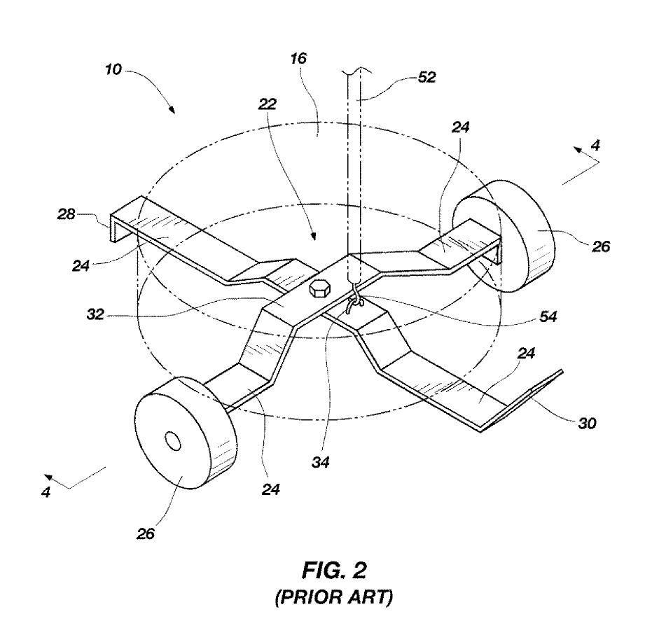

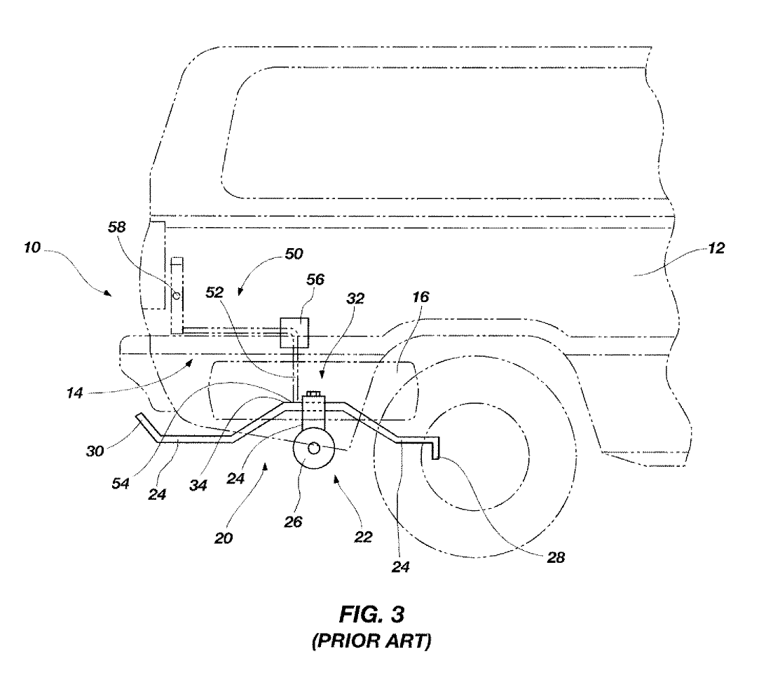

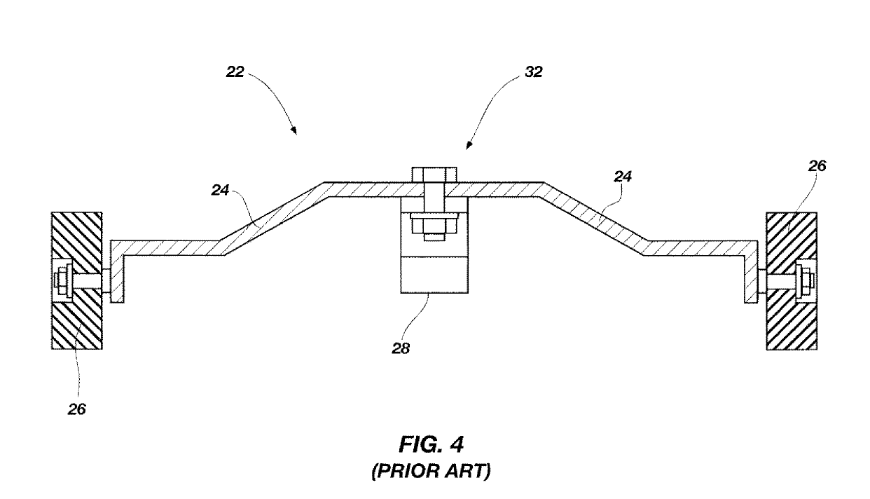

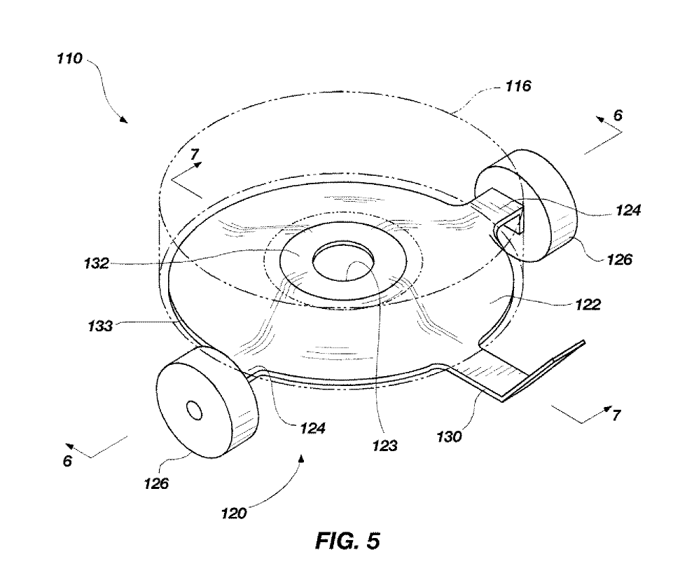

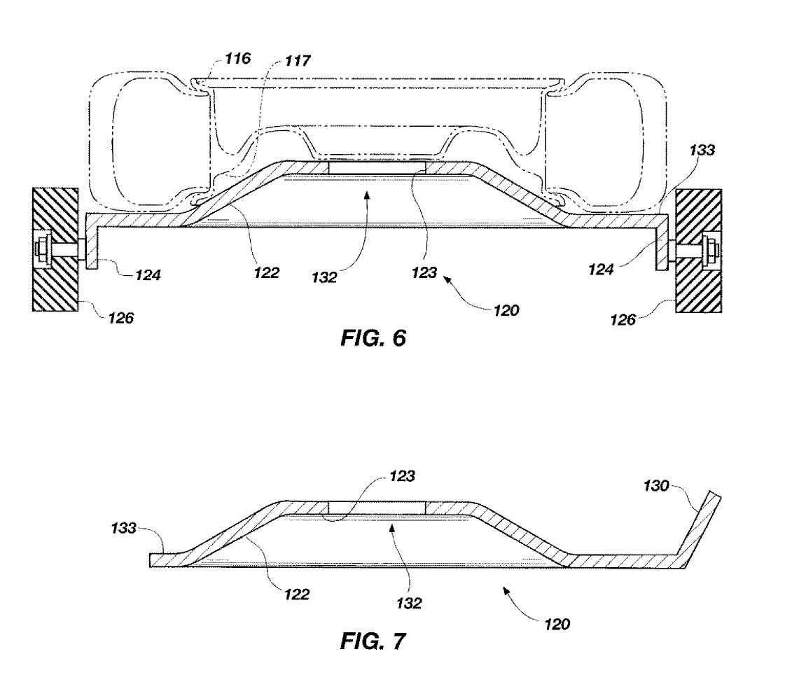

FIG. 5 shows a perspective view of an improved removable tire caddy 110 in accordance with the first embodiment the invention. Reference may also be made to FIGS. 6 and 7, which show cross sectional views of a unitary carriage 120 taken along their respective lines as indicated in FIG. 5. The improved removable tire caddy 110 may generally comprise two main assemblies. The first assembly is the carriage 120 and the second assembly is a conventional spare tire lift and carry apparatus 50 (see FIG. 1).

The unitary carriage 120 may comprise a frame 122 for supporting a spare tire assembly 116. The invention, like the conventional removable tire caddy 10 mentioned above, may incorporate the conventional spare tire lift and carry apparatus 50 for retracting and releasing a spare tire 116 and the carriage 120 with respect to an undercarriage of a vehicle. However, other spare tire lift and carry apparatuses may be advantageously utilized upon a vehicle for receiving the carriage 120 of the invention.

The frame 122 is a unitary member that is part cone-like and radiates from a central portion 132 and extends to a rim cover or outer edge 133, which is a distance sufficient to contact and support an ample portion of the spare tire assembly 116, but the unitary carriage 120 is not so limited as it may include accessories that extend within or beyond the frame 122. For example, the carriage 120 may employ two wheels 126 coupled to the outer edge 133 of the frame 122 and still function as described. The unitary carriage 120 allows the spare tire lift and carry apparatus to be coupled generally to the central portion 132 of the frame 122, enabling it to be releasably secured to a vehicle when a spare tire assembly 116 is or is not attached thereto. The unitary carriage 120 generally provides protection to the spare tire assembly 116 from road debris or other hazards. In this regard, the frame 122 of the unitary carriage 120 provides substantial cover for at least a rim 117 of the spare tire assembly 116 because of carriage's unitary construction.

The frame 122, being of unitary construction, includes an attachment location 123, two wheel connector supports 124 and a handle 130. The frame 122 is a unitary member in that the attachment location 123, the wheel connector supports 124 and the handle 130 are all part of the same member. The frame 122, optionally, is a unitary member in that a substantial portion of the frame 122 radially extends between the attachment location 123 and the outer edge 133 in order to provide a protective barrier for the rim 117 of the spare tire assembly 116 when attached thereto. In this regard, the frame 122 is substantially continuous in its cone-like surface, but it may include holes for venting of particulate, for interfacing with the spare tire assembly 116 or for providing additional support for the spare tire lift and carry apparatus.

The frame 122 of this embodiment is made from a reinforced plastic sheet molded into the desired shape. Optionally, the frame 122 may be made from other materials such as composite materials, metal, or plastic, for example, without limitation. The frame 122 is cone-like to better receive and support the spare tire assembly 116 to fit within its central cavity, but it is recognized that the frame 122 may be flat, straight, semi-torus, or custom countered to better facilitate receiving the rim 117 or providing protection thereto from road debris when placed into service upon an operational vehicle. In this aspect, the frame 122 raises the attachment location 123 higher than the outer edge 133 thereby providing improved fit with the spare tire assembly 116 as illustrated in FIG. 6.

The wheel connector supports 124 are substantially aligned, allowing attached wheels 126 to rotate general in the same direction to facilitate movement and positioning of the carriage 120 by a user. Wheels 126 may be located at two or more ends of the wheel connector supports 124. Practical placement may include generally opposing ends of the wheel connector supports 124 and may comprise several wheel types such as a simple solid wheel and axle as depicted in the drawings, or optionally caster wheels, pneumatic wheels, multi wheel treads, collapsible wheels, pedrail wheels, etc., employed with or without an articulated suspension structure.

The handle 130 is integral with the frame 122, however it is recognized that the handle 130 may also be releasably attachable thereto. In this regard, the handle 130 may simply comprise a section of the frame 122 formed so that the user may grip it, or optionally may include a sleeve of conformable material formed in a configuration fashioned for gripping. The handle 130 may be mounted in a horizontal, vertical, or diagonal position relative to the frame 122. The handle 130 in this embodiment is positioned forward of the side mounted wheels 126 to facilitate removal from beneath a vehicle.

To promote more convenient use of the handle 130 with the carriage 120, it may be beneficial to set the weight of the frame 122 slightly off center. The center of gravity may be positioned slightly toward the handle end of the fulcrum defined by the axles of the wheels 126. In this configuration, the weight of the carriage 120 may be distributed substantially on the wheels 126 with a portion of the weight being borne toward the handle 130. This design would assure that, when idle, the carriage would rest toward the handle leaving it free to be easily grasped and preventing the carriage from rolling away.

An engagement device (not shown) may be incorporated on the central portion 132 of the carriage 120. Such a device may comprise a variety of structures to attach a cable to the carriage. For example, such structures may include a hook, an eye bolt, a hole, a clamp, a clip, a latch, an open loop, a spring fastener, a narrowed portion of the attachment location, a tension connector, a capture block and a bell plate, without limitation. Devices for attaching a cable to an object are known to those of skill in the art and it is anticipated that any of these methods or devices may be employed to practice the invention described herein. The cable engagement device, as described above, may be used to connect the carriage with or without a spare tire to a spare tire lift and carry apparatus 50. The cable engagement device may advantageously securely store the carriage 120 by engaging, in this embodiment, the attachment location 123 of the central portion 132 of the frame 122 against a vehicle when used without a spare tire. Likewise, the cable engagement device may advantageously securely store the carriage 120 when used with a spare tire by engaging the central portion 132 of the frame 122 and sandwiching the spare tire against a vehicle.

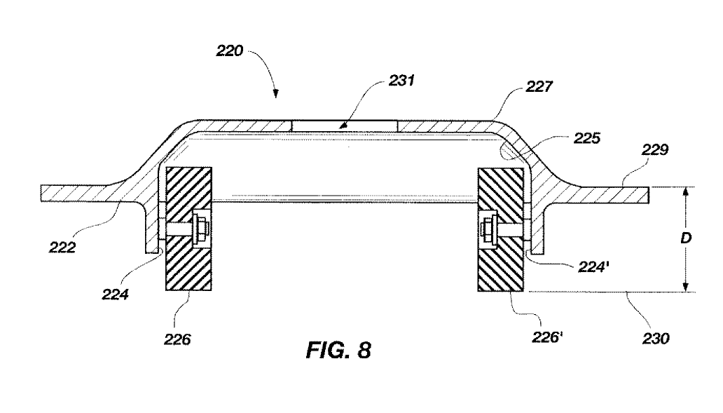

FIG. 8 shows a cross section view of another unitary carriage 220 in accordance with a second embodiment of the invention. The unitary carriage 220 includes a unitary frame 222 and two wheel assemblies 226, 226′. The wheel assemblies 226, 226′ are advantageously mounted on their oppositely opposed inner connector supports 224, 224′ located on an inner underside surface 225 of the frame 222, providing improved storage of the carriage 220. Optionally the unitary carriage 220 may have a single wheel or roller that extends between the inner connector supports 224, 224′.

Also, the wheels of the wheel assemblies 226, 226′ may be mounted to obtain a low profit frame or carriage design. In this respect, the wheel assemblies 226, 226′ include low profile wheels such that when the wheels are mounted upon the inner connector supports 224, 224′, a vertical distance D between the brim 229 and a lowest extremity surface 230 of the low profile wheels is minimized while allowing the wheel assemblies 226, 226′ rotationally carry the carriage 220 upon a substantially flat surface.

The frame 222 of this embodiment is top-hat shaped having an outer surface 227 for receiving a spare tire assembly (not shown) and a brim 229 for sportingly receiving the tire. As with the first embodiment, a spare tire lift and carry apparatus (not shown) may engage an inner rim 231 of the frame 222 for hoisting or lowing the carriage 220.

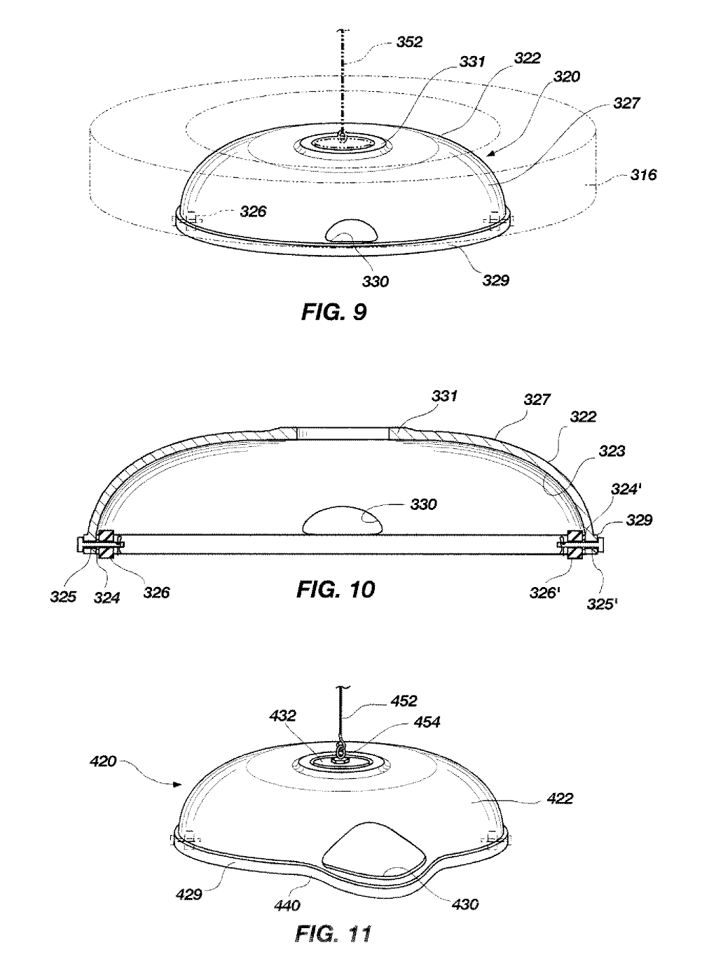

FIG. 9 shows a perspective view of yet another unitary carriage 320 in accordance with a third embodiment of the invention. FIG. 10 shows a cross section view of the unitary carriage 320. The unitary carriage 320 includes a unitary frame 322 and two wheel assemblies 326, 326′. The wheel assemblies 326, 326′, located on an inner underside surface 323 of the frame 322, are rotationally mounted on their oppositely opposed inner connector supports 324, 324′ and secured thereto by two support sleeves 325, 325′, respectively. Improved compact storage of the carriage 320 when used with a vehicle is provided by locating the wheel assemblies 326, 326′ on the underside surface 323 of the frame 322. Optionally, the wheel assemblies 326, 326′ may be mounted on an outside surface 327 of the frame 322.

The support sleeves 325, 325′ of this embodiment are made from steel and are coupled in the carriage 320. Optionally, the sleeves 325, 325′ may be made from any other material including ceramic, reinforced plastics or non-metallic materials, for example, without limitation. Also, the sleeves 325, 325′ may be slideably attached, form molded or press fit into respective inner connector supports 324, 324′, for example, without limitation.

The frame 322 of this embodiment is an inverted-bowl shape having the outer surface 227 for receiving a spare tire assembly 316 and includes a hand grip or extension 330 formed in a thickened outer rim 329. The thickened outer rim 329 provides structural support not only for the frame 322, but also for the extension 330. The thickened outer rim 329 of this embodiment provides structural support for the carriage 320.

The frame 322 may further include a thickened inner rim 331 for receiving a cable assembly 352. The thickened inner rim 331 of this embodiment provides structural support when a cable assembly 352 of a spare tire lift and carry apparatus (not shown) engages the inner rim 331 of the frame 322 for supporting hoisting or lowing the carriage 320.

FIG. 11 shows a perspective view of still another unitary carriage 420 in accordance with a fourth embodiment of the invention. The carriage 420 includes a unitary frame having an outer rim 429 and an extended grip handle 430. The extended grip handle 430 is formed in a frontal portion 440 of the outer rim 429 in order to allow improved access by a user when positioning the carriage 420.

The carriage 420 of this embodiment also includes an engagement device 454 that may be incorporated on the central portion 432 of the carriage 420. The engagement device 454 is an eye bolt in this embodiment, but it is recognized that it may comprise a variety of other structures suitable for attaching a cable 452 of a tire lift and carry apparatus (not shown) to the carriage 420.

In embodiments of the invention, the wheel connector supports may be in rotational alignment and opposed about the central portion of the frame. Further, each wheel connector support may extend beyond the outer edge of the frame and includes a wheel assembly coupled thereto, in order that a spare tire may be received between the opposed wheel assemblies without rotationally interfering with the wheel assemblies.

In other embodiments of the invention, the handle extension may extend from the outer edge, in a general radial direction from the central portion to the outer edge of the frame. Further, the handle extension may substantially align normal to an axial direction of the wheel connector supports. The handle extension provides convenient access for a user to grip and move the carriage.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the invention.

While particular embodiments of the invention have been shown and described, numerous variations and alternate embodiments will occur to those skilled in the art. Accordingly, it is intended that the invention be limited in terms of the appended claims.

1. A unitary carriage for use with a tire caddy comprising:
a frame comprising a unitary member that radiates from a central portion to an outer edge configured for engaging a spare tire lift and carry apparatus and supporting a spare tire, the unitary member of the frame including a plurality of wheel connector supports and a handle extension; and
at least one wheel assembly coupled to one of the wheel connector supports of the frame.

2. The unitary carriage of claim 1, wherein the outer edge extends radially from the central portion of the frame a distance sufficient for shielding a substantial portion of the spare tire.

3. The unitary carriage of claim 1, wherein the unitary member comprises reinforced plastic.

4. The unitary carriage of claim 1, wherein the central portion of the frame forms a cone-like structure.

5. The unitary carriage of claim 1, wherein the unitary member includes two wheel connector supports in rotational alignment and opposed about the central portion of the fame, each connector support having one wheel assembly coupled thereto,

6. The unitary carriage of claim 5, wherein the two wheel connector supports are inner connector supports located on an inner underside surface of the frame.

7. The unitary carriage of claim 1, wherein the unitary member includes two wheel connector supports in rotational alignment and opposed about the central portion of the frame, each connector support having a wheel assembly coupled thereto and each connector support extending beyond the outer edge of the frame to receive a spare tire therebetween without rotationally interfering with the wheel assemblies.

8. The unitary carriage of claim 1, wherein the wheel connector supports are inner connector supports.

9. The unitary carriage of claim 1, wherein the handle extension extends from the outer edge, in a general radial direction from the central portion to the outer edge of the frame, and is substantially aligned normally to an axial direction of the wheel connector supports.

10. The unitary carriage of claim 9, wherein the handle further includes a grip that extends upwardly with respect to the general radial direction.

11. The unitary carriage of claim 1, wherein the handle extension is configured for receiving a connectable handle, the handle extension extends from the outer edge, in a general radial direction from the central portion to the outer edge, and is substantially aligned normally to an axial direction of the wheel connector supports.

12. The unitary carriage of claim 1, further comprising an engagement device incorporated on the central portion of the unitary member of the frame.

13. The unitary carriage of claim 1, wherein the handle extension is a hand grip.

14. The unitary carriage of claim 1, wherein the unitary member includes at least one vent hole.

15. A removable tire caddy for use with a vehicle comprising:
a spare tire lift and carry apparatus mounted on the underside of a vehicle, the apparatus including a cable depending downwardly from the underside of the vehicle and a coupling device mounted on a free end of the cable; and
a unitary carriage for supporting a tire assembly that couples to the spare tire lift and carry apparatus of the vehicle, the unitary carriage comprising:
a frame comprising a unitary member that radiates from a central portion to an outer edge, the unitary member of the frame includes a plurality of wheel connector supports and a handle extension; and
at least one wheel assembly coupled to one of the wheel connector supports of the frame.

16. The removable tire caddy of claim 15, wherein the outer edge radially extends from the central portion of the frame a distance sufficient to substantially shield a rim portion of the tire assembly.

17. The removable tire caddy of claim 15, wherein the unitary member is made from reinforced plastic.

18. The removable tire caddy of claim 15, wherein the frame is uplifted forming a brimmed hat-like structure, the raised central portion being nestable in an inner hub of the tire assembly and the coupling device being received substantially in the central portion of the frame.

19. A method of using a removable tire caddy for use with a vehicle comprising:
providing a spare tire lift and carry apparatus mounted on the underside of a vehicle;
providing a unitary carriage comprising a frame, the frame being a unitary member that radiates from a central portion to an outer edge, and an engagement member substantially incorporated on the central portion of the unitary member;
mounting a tire upon the unitary carriage;
after mounting, receiving the engagement member of the unitary carriage on the coupling device; and
shielding the tire with the unitary carriage.

20. The method of claim 19, wherein receiving includes raising, storing and lowering the unitary carriage with the coupling device of the spare tire lift and carry apparatus, and further comprising releasing the engagement member of the unitary carriage from the coupling device upon lowering, and retrieving the unitary carriage from under the vehicle upon releasing.
